(19) United States
(12) Patent Application Publication
(10) Pub. No.: US 2010/0274661 A1
(43) Pub. Date: Oct. 28, 2010

(54) OPTIMIZATION OF ADVERTISING CAMPAIGNS ON MOBILE NETWORKS

(75) Inventors: Janne Aaltonen, Turku (FI); Timo Ahopelto, Helsinki (FI); Pekka Ala-Pietilä, Helsinki (FI)

Correspondence Address: BARNES & THORNBURG LLP, 750-17TH STREET NW, SUITE 900, WASHINGTON, DC, 20006-4675, US

(73) Assignee: Cvon Innovations LTD, London (GB)

(21) Appl. No.: 12/447,941

(22) PCT Filed: Nov. 1, 2006
(86) PCT No.: PCT/FI06/00349

§ 371 Date: Jul. 1, 2010

(51) Int. Cl. G06Q 30/00; G06F 17/30

(52) U.S. Cl. 705/14.42; 705/14.64; 705/14.58; 707/769; 707/E17.014

(57) ABSTRACT

The present invention provides a method and system for optimizing advertising campaigns on mobile networks using feedback from the advertisement audience community.

### FIELD OF THE INVENTION

The present invention relates to mobile marketing and to optimization of advertising campaigns on mobile networks.

### BACKGROUND OF THE INVENTION

Creation of an advertising campaign requires substantial investment of resources. When an advertiser is selecting the method to use, the key criterion is the estimated impact of the selected marketing activity. Usually the impact is estimated based on how well the desired target audience is identified and reached, and target audience's expected response to the delivered marketing message. Ultimately, marketing impact turns into the advertiser's ROI (return on investment) measured via e.g. new product purchases based on the executed campaign, or measured increase in brand recognition or loyalty.

Today's mobile marketing is usually mostly based on push campaigns to opt in a consumer mobile number database, or pull campaigns that acquire mobile phone numbers from consumers. The most typical example of a pull campaign is a “text-to-win” campaign where, e.g. a soft drink bottle contains a short code, which is sent via a text message to a certain number. In return, the consumer receives a notification if he/she has won with a selected marketing message or a series of messages being broadcasted to his/her mobile phone. The advertisers purchase such campaigns from operators or agents that are in business of delivering advertisements to consumers.

When making an advertising campaign there is a risk of making wrong type of advertisements to wrong target audience. Advertisements have been typically tested with focus groups representing the target audience before the campaign or as visibility polls after the campaign is performed. With traditional methods it is hard or impossible to change the already committed campaign and thus the investment is lost if it is noticed during the campaign that it is not effective.

Despite the obvious advantages of the mobile media—personal, always-on, portable, rich content capabilities, interactivity, networking characteristics—the same challenge than with other media exists: how to ensure the highest ROI via targeting the right segment with the right message. Current advertising systems and methods are unable to provide flexibility and performance required to manage advertising campaigns on mobile networks where multiple possible delivery mechanisms exist.

### SUMMARY OF THE INVENTION

The main object of the present invention is to reduce or even eliminate the prior art problems presented above.

One object of the invention is to provide a method and system enabling to verify an advertising campaign beforehand.

One object of the invention is to provide a method and system enabling to alter an advertising campaign on the fly if needed.

One object of the invention is to provide a method and system enabling to forecast the impact of an advertising campaign.

One object of the invention is to provide a method and system enabling to optimize a chain of advertisements where advertisements follow each other.

One object of the invention is to provide a method and system enabling to optimize an advertising campaign in a mobile environment, where multiple possible delivery mechanisms for the advertisements with different cost and impact are present.

In order to realize the above mentioned objects, the method and system according to the invention are characterized by what is presented in the characterizing parts of the appended independent claims.

The exemplary embodiments presented in this text and their advantages relate by applicable parts to the method as well as the system according to the invention, even though this is not always separately mentioned.

A typical method for processing messages and feedback according to the invention comprises:
selecting a message, from messages stored in a message database, to each consumer in a first group of consumers, which selecting is based on information read from a consumer database,
selecting a delivery mechanism for each said selected message, which selecting is based on information read from the consumer database,
transmitting said selected messages using said selected delivery mechanisms to said first group of consumers through a cellular system,
receiving feedback from said first group of consumers.

In a typical method according to the invention the selecting of next message to be sent and the selection of next delivery mechanism is based on said received feedback.

A typical system for processing messages and feedback according to the invention comprises:
a message database configured to store messages,
a consumer database of a cellular system configured to store information that describes properties of consumers,
a consumer selecting arrangement configured to select at least a first group of consumers based on information read from said consumer database,
a message selecting arrangement configured to select messages from said message database to the first group of consumers based on information read from said consumer database,
a delivery mechanism selecting arrangement configured to select a delivery mechanism to each selected message based on information read from said consumer database,
a transmission arrangement configured to transmit selected messages to the first group of consumers through said cellular system,
a receiving arrangement configured to receive feedback from consumers to which messages have been sent through said cellular system,

In a typical system according to the invention
the message selecting arrangement is configured to select the messages based also on said received feedback, and
the delivery mechanism selecting arrangement is configured to select the delivery mechanism based also on said received feedback.

In other words, the present invention provides a method and system for optimizing advertising campaigns on mobile networks using feedback from the advertisement audience community.

It has thus now been surprisingly found that by using data received by feedback from those who received earlier messages together with data present in a consumer database, the selecting of the next messages and their mobile delivery mechanisms enables to modify the chain of messages in an advertising campaign. With the invention the response pattern of the consumers can be followed and utilized in an effective way. Advertisements and their mobile delivery mechanisms can be selected in such a way that each consumer is provided with messages that suit the technical specifications of each consumer's mobile terminal. Furthermore, the invention enables selection of advertisements and their mobile delivery mechanisms in such a way that the information content of each message can be selected to suit the needs of the consumer. Typically in a mobile communication network the costs for sending a message are different according to the delivery mechanism used for the message. The invention makes it possible to take into account cost impact of multiple delivery mechanisms available in the mobile infrastructure. The invention makes it possible to optimize the ROI of advertisements via targeting the right consumer segment with the right message.

Embodiments of the present invention improve and bring a new solution to optimization of advertising campaigns on mobile networks by altering not only the advertisement but expanding a single advertisement approach to a chain of advertisements and by providing in a method for weighting a selection tree structure of a chain advertising campaign.

Embodiments of the present invention enable construction of several different selection tree structure modifications for an advertising campaign with help of grouping people to peer groups (i.e. social networks or community members) and following how these peer groups select and response to advertisements, and identifying the highest responding subgroups among the recipients. Embodiments of the invention also bring benefit compared to the prior art by bringing a method to modify advertisements to fit multiple different groups. According to embodiments of the invention chain advertising campaign can be run in several phases to utilize the resulting response pattern in real-time to optimize the campaign and estimate campaign's impact.

Delivering messages according to embodiments of the invention is typically carried out in a communication network. Some examples of the communication networks are the Universal Mobile Telecommunications System (UMTS) radio access network (UTRAN), Global System for Mobile Communications (GSM) and its modifications, Wireless Local Area Network (WLAN), Worldwide Interoperability for Microwave Access (WiMAX), Bluetooth™, Personal Communications Services (PCS), systems using ultra-wideband (UWB) technology, broadcasting networks such as Digital Video Broadcasting for Handheld (DVB-H), Terrestrial Integrated Services Digital Broadcasting (ISDB-T), Digital Audio Broadcasting (DAB), Digital Multimedia Broadcasting (DMB) or cellular based broadcasting networks such as Multimedia Broadcast Multicast Service (MBMS) and its modifications.

A message database is an electronic database maintained in an electric memory of a computer. A message database comprises a plurality of electric messages to be used in a method of the invention, e.g. in an advertising campaign. Typical examples of types of messages are text messages, picture messages, video messages, audio messages, electronic mail messages, hyper-text markup language (html) based messages.

Messages are typically delivered via communication network using a delivery method, such as short message service (SMS), multimedia messaging services (MMS), wireless application protocol (WAP), WAP-push, as video streaming, as video download, as audio streaming, as audio download, via electronic mail, via Internet connectivity, via multicasting or broadcasting, via phone call.

A delivery mechanism can be defined as a combination of communication network, used delivery method and message type.

By a consumer is meant a person whose information is stored in a consumer database of the invention. A typical consumer has a mobile terminal with certain technical specifications. A consumer in the respect of the invention refers also to a person who is receiving messages via communication channel.

Messages are received with a user device, which may be a mobile phone, a laptop, a personal digital assistant (PDA), a personal computer (PC) or a multimedia device, for instance.

A consumer database is an electronic database maintained in an electric memory of a computer. A consumer database comprises information on a plurality of consumers. Such information can comprise e.g. consumer's mobile phone number MSISDN, phone type, terminal capabilities, demographics, brand preferences, delivery preferences, phone IMEI codes, social network connections, usage patterns of media, purchasing patterns, gender, age, address, location.

By a group of consumers is meant a plurality of consumers selected from the consumers having their information stored in the consumer database.

The advertiser typically defines campaign parameters for an advertising campaign. The campaign parameters are typically stored in the consumer database. The campaign parameters define e.g. certain consumer profiles. By a consumer profile is meant a group of consumers defined by certain similar properties or pieces of information stored as information in the consumer database. Examples of properties that may be common factors in a consumer profile are: mobile phone model, geographic location at a certain point of time, age, gender, sociological background, income level, purchasing habits.

One or more target groups of consumers, to which advertisement messages are to be sent, are selected among the consumers stored in the consumer database. One target group can comprise consumers in one or more consumer profiles. In other words, by a target group is meant a group of consumers, which are potentially receiving messages according to the invention.

Typically the advertiser inputs advertisements, which are fed to the message database of the advertising campaign system. These messages are typically part of an advertising campaign material, typically designed by an advertising agency. Typical campaign material comprises e.g. texts, images, sounds, videos, hyper-text markup language (html), tags, links, coupons.

By feedback is meant direct feedback, i.e. messages manually produced and/or sent by consumers. Such direct feedback includes e.g. answers to questions, whether a link in a message was selected or not, whether a message was opened or not, whether a message was read or not, whether a message was received or not, whether a message was forwarded or not, information on made selections provided for in previous messages, whether a sent coupon was used or not. Direct feedback can be obtained from received answer messages to previous messages.

By feedback is also meant indirect feedback, i.e. messages and/or data that describe the actions of the consumer, but which is provided by the mobile communication network or by user devices automatically and/or without the knowledge or manual actions by the consumer or without the consumer himself/herself manually answering to any messages. One example of indirect feedback is knowledge on where the consumer or a user device is and in what direction he/she/it is moving. Indirect feedback can be used to analyze impact of the messages. For example if message for a target group of consumers is: “Speak more” and increased voice activity is observed in the target group of consumers in the network it can be concluded that the message had an effect.

The feedback can be obtained e.g. from a user device, communication network infrastructure, from a shop where an advertisement coupon or identification code has been used or from some other sources. The feedback information typically includes subscriber identity code and advertisement identity code in order to identify both the consumer and the marketing message successfully delivered. The feedback can be received via the cellular network or via some other means, e.g. via Internet.

A cellular system is a radio system providing mobile telephone service via a network of interconnected, low-powered base stations, each of which serves a geographic area.

According to an embodiment of the invention the method can be described as follows: One or more messages with similar or different content are sent to the first group of consumers, feedback is received, modifications to the messages are made according to the feedback. This process can be iterated as many times as needed.

According to an embodiment of the invention the first group of consumers is a test group with which an advertising campaign is tested and optimized with one or more messages and iterations.

According to an embodiment of the invention after the advertising campaign is tested and optimized with the first group of consumers, messages are sent to a second group of consumers. The second group can be a further test group or the final target group of the advertising campaign. There can be more than two test groups, e.g. 3, 4, 5, 6, 7, 8, 9 or 10 test groups before the final target group of the advertising campaign is used. The different groups of consumers can comprise one or more same individual consumers.

According to an embodiment of the invention messages selected are identical, i.e. one and the same message is selected to each consumer of said first group of consumers. This is useful e.g. when testing the effect of a certain message.

According to an embodiment of the invention the selected delivery mechanism is identical for all messages sent to one group of consumers. The messages with identical delivery mechanism can have identical or different information content.

According to an embodiment of the invention received feedback is direct feedback from said first group of consumers to previous selected messages.

According to an embodiment of the invention the received feedback is indirect feedback based on consumers' behaviour.

According to an embodiment of the invention the received feedback is received through the cellular system and/or Internet.

According to an embodiment of the invention said selecting the message and the delivery mechanism is based on received feedback from several, or all, consumers in the first group of consumers. In other words, feedback from several consumers, e.g. every feedback from one group of consumers to one message, is processed into a summary, and the selection of the next message and delivery mechanism is based on said summary. A summary can be e.g. an average value of the feedback.

According to an embodiment of the invention said selecting the message and the delivery mechanism is based on received feedback from one consumer in the first group of consumers. A consumer can be defined in the consumer database as an alpha member in a group, i.e. a very influential person or an opinion leader inside one group. Feedback of an alpha member can be regarded so dominating, that the selection of the next message and delivery mechanism for the whole group can be made based on the feedback of the alpha member only.

It is also possible that selection of a message and delivery mechanism to a consumer is based only on feedback from the consumer himself/herself.

According to an embodiment of the invention said information read from said consumer database describes, how consumers utilize features of said cellular system. This can mean e.g. what delivery mechanisms consumers utilize.

According to an embodiment of the invention said first group of consumers is a peer group. A peer group is a subgroup of a society in which membership is determined by similar age, sharing the same social status, etc.

According to an embodiment of the invention selected messages for one group of consumers advertise one and the same product.

According to an embodiment of the invention said selection of the delivery mechanism comprises selecting the way of delivering the message using: SMSC, MMSC, WAP-GW, Internet AP, cellular network, broadcast network, wireless local area network.

According to an embodiment of the invention transmission time of said selected messages and/or receiving time of feedback to said selected messages is stored in said consumer database. Such time information is then used in selecting the message and the delivery mechanism.

According to an embodiment of the invention physical location of consumers, i.e. their mobile terminals from which feedback has been received, is stored in said consumer database. Such information is then used in selecting the message and the delivery mechanism.

According to an embodiment of the invention information content of said received feedback is stored in said consumer database. Such information content is then used in selecting the message and the delivery mechanism.

According to an embodiment of the invention consumers' mobile terminal types are stored in said consumer database. Such information is then used in selecting the message and the delivery mechanism. Mobile terminal type defines the technical specifications of a mobile terminal. The technical specifications define which delivery mechanisms can be used when sending messages to the consumer.

According to an embodiment of the invention the method further comprises:
selecting a message, from messages stored in said message database, to each consumer in a second group of consumers, which selecting is based on information read from said consumer database,
selecting a delivery mechanism for each said selected message, which selecting is based on information read from said consumer database,
transmitting said selected messages using said selected delivery mechanisms to said second group of consumers through said cellular system,
receiving feedback from said second group of consumers, wherein
the selecting the message and the delivery mechanism for consumers in the second group of consumers is based on said received feedback from the first group of consumers.

It is also possible that the selecting the message and the delivery mechanism for consumers in the second group of consumers is based on said received feedback from the second group of consumers, if this feedback is already available.

The selecting of the message and the delivery mechanism can be based on received feedback from one or several consumers in the first or the second group of consumers.

According to an embodiment of the invention the selection of the messages to a group of users is based on feedback of the previously sent messages to a previous group of users.

According to an embodiment of the invention the selecting of the message and the delivery mechanism is based on
calculating a cost per response ratio for each selected message and delivery mechanism combination, and for each consumer profile,
calculating a sales profit estimate for said ratios,
determining if the target level of information is available; if not, then receiving more feedback, and
determining delivery mechanisms, which maximize impact of the campaign for each message and each consumer profile.

The target level of information means that predetermined type, level and quality of feedback has been collected or the change between two or more previous test rounds have resulted to predetermined level of change.

According to an embodiment of the invention the selecting of a delivery mechanism comprises the selection of one or more of the following:
a communication network to be used for the delivery of the message,
a delivery method to be used for the message to be sent,
a message type of the message to be sent.

Being computer-related, it can be appreciated that the components disclosed herein may be implemented in hardware, software, or a combination of hardware and software. Software components may be in the form of computer-readable program code stored in a computer-readable storage medium such as memory, mass storage device, or removable storage device. For example, a computer-readable medium may comprise computer-readable code for performing the function of a particular component. Likewise, computer memory may be configured to include one or more components, which may then be executed by a processor. Components may be implemented separately in multiple modules or together in a single module.

### BRIEF DESCRIPTION OF THE DRAWINGS

For better understanding of the present invention, reference will now be made by way of example to the accompanying schematic drawings in which:

FIG. 1 is a block diagram of a mobile advertising system that may be used in embodiments of the present invention;

FIG. 2 is a block diagram illustrating the components of a cellular system for conveying indirect feedback to an advertising campaign system;

FIG. 3 shows a flow diagram of a method of optimizing delivery mechanisms during a test campaign phase;

FIG. 4 shows a flow diagram of a method of optimizing delivery mechanisms during the campaign;

FIG. 5 shows a graph illustrating a cost per response ratio as a function of response rate according to an example;

FIG. 6 shows a graph illustrating a cost per response ratio as a function of response rate according to another example;

FIG. 7 shows an example of a tree structure of a chain advertising campaign;

FIG. 8 shows an embodiment of how the feedback is used to modify a marketing campaign; and

FIG. 9 shows an embodiment where feedback is used to continuously fine-tune a marketing campaign.

### DETAILED DESCRIPTION OF THE INVENTION

The same reference signs are used of the same or like components in different embodiments.

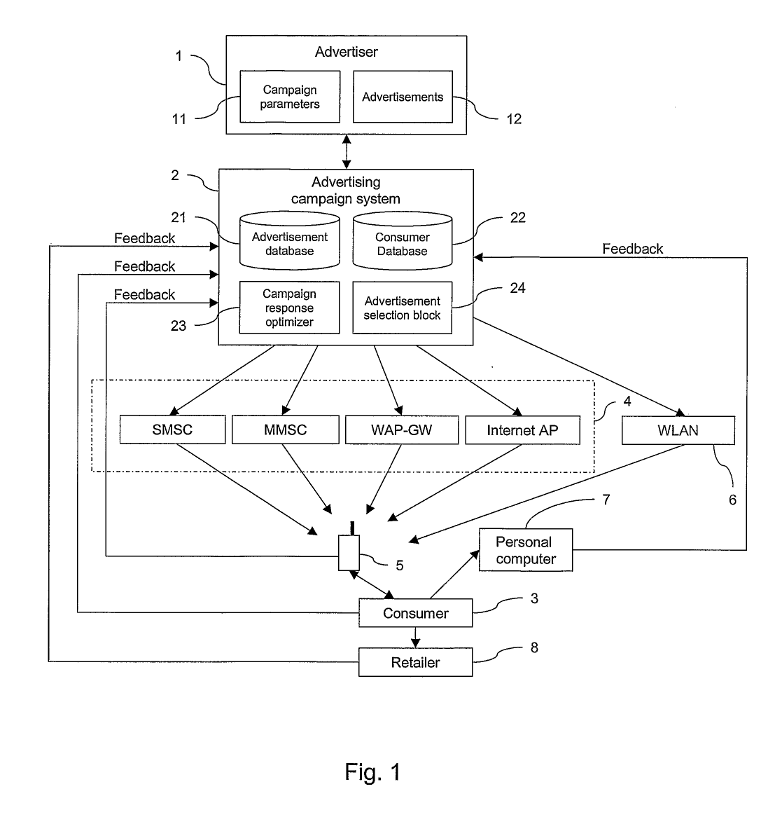

FIG. 1 shows a block diagram of a mobile advertising system according to the invention. An advertiser 1 is a party that wants to advertise products or services to consumers 3 in a mobile communication network. An advertising campaign system 2 is operated by an advertisement delivery company. An advertisement delivery company is in business of delivering advertisements from several advertisers 1 to several consumers 3. The advertising campaign system 2 comprises means for the advertiser 1 to define rules of the advertising campaign. Parameters which are used can include e.g. target audience, demographics of the target audience, cost per advertisement, type of advertisement, sociological background of the target audience, age, gender, target phone type, and income level. These rules are used when optimizing an advertising campaign or a chain advertising campaign as described below.

The advertiser 1 and the party operating the advertising campaign system 2 and communication network 4, i.e. a cellular system, can be one and the same party. These systems can be operated by different parties or a combination of systems can be operated by a single party. The systems can be physically in the same device or can be run in separate computer systems.

The advertiser 1 inputs campaign parameters 11 and advertisements 12, which are fed to an advertisement database 21 of the advertising campaign system 2. The campaign parameters 11 define e.g. certain consumer profiles i.e. one or more consumers with similar properties. The campaign parameters 11 are also stored in a consumer database 22. The consumer database 22 comprises information about the consumers 3, i.e. users of a mobile communication network. One or more target groups of consumers, to which advertisement messages are to be sent, are selected among the consumers stored in the consumer database 22. One target group can comprise consumers in one or more consumer profiles. The consumer database 22 contains for example information of consumer's mobile phone number MSISDN, phone type, terminal capabilities, demographics, brand preferences, delivery preferences, phone IMEI codes, gender, age, and geographical location at a certain time.

In a cellular system 4 (Global System for Mobile Communications (GSM), Code Division Multiple Access (CDMA), Wideband Code Division Multiple Access (WCDMA) etc.) there are several methods for delivering content to consumers 3 with a mobile terminal 5. The methods can include, but are not limited to, short message service (SMS) messages delivered via short message service center (SMSC), multimedia messaging service (MMS) messages delivered via multimedia messaging service center (MMSC), wireless application protocol (WAP) messages delivered via wireless application protocol gateway (WAP-GW), and content delivered via Internet access point (Internet AP). In addition, advertisements can be delivered over local area networks such as wireless local area network (WLAN) 6, Bluetooth (BT) or over other networks such as WiMAX, broadcast networks such as DMB, DVB-H, ISDB-T to mention few. For the clarity only five possible delivery mechanisms are shown in FIG. 1.

In order to verify success rate of an advertisement one important parameter often used is the response rate of the advertisement. The response rate refers to one or more of the consumers 3 responding to the advertisement. The feedback can be, for example answering to a questionnaire using a mobile terminal 5 or a personal computer 7, selecting from options in question, using an electric send coupon, or purchasing an advertised product e.g. from a retailer 8.

Feedback is fed to the advertising campaign system 2. The feedback can be provided directly to advertiser 1, which then can forward it to the advertising campaign system 2 when needed. A campaign response optimizer 23 utilizes feedback, and information stored in the advertisement database 21 and the consumer database 22 to determine which delivery mechanism is best for a given consumer and consumer profile. In other words, the purpose of the campaign response optimizer 23 is e.g. to follow response rate of an ongoing advertising campaign, to analyze feedback and to do modifications to the advertising campaign accordingly. An advertisement selection block 24 selects and sends the actual advertisement to the mobile terminal 5 of the consumer 3 through the cellular system 4. The selected and sent advertisement type, and transmission time are stored in the consumer database 22. The feedback to said advertisement from said consumer, the location of said consumer and receiving time are also stored in the consumer database 22 in order to understand consumer behaviour better.

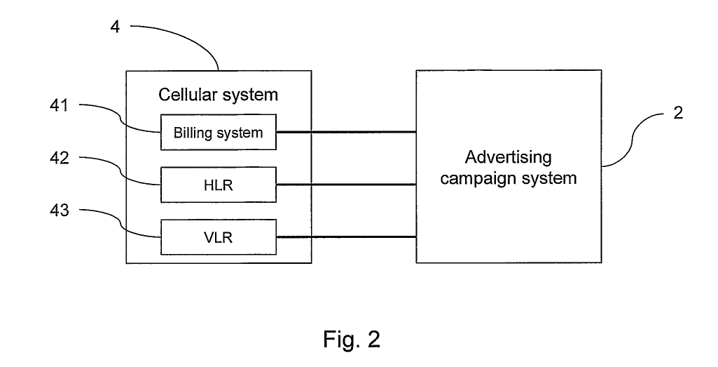

Feedback from the consumers 3 to the sent advertisements can be direct and/or indirect. According to one embodiment of the invention indirect feedback is retrieved from a billing system 41 (pre-paid/post-paid) of a cellular system 4 as shown in FIG. 2. The billing system 41 is typically the same what the operator uses for billing the consumers. This approach makes it possible to convey indirect feedback of the consumer behaviour before and after said advertisement message or messages have been sent to the mobile terminal 5 of the consumer 3. The indirect feedback can be in form of change in the balance of the billing system 41 for the consumer 3. Furthermore, indirect feedback can be information from the billing system 41 relating to the usage of communication network services in general or in particular after and before receiving said message. One example of such information usage is the information of does the consumer send mostly SMS or MMS messages or does the consumer call more calls than receive.

Typically billing systems 41 or other communication network nodes collect call detail records (CDR) of to which number consumer calls, to which number consumer sends messages or from which number consumer receives calls or messages. This CDR information can be used to collect indirect feedback on the behaviour of the consumer 3 before and after the marketing message has been sent. An example of such usage can be forwarding the message to another person.

Indirect feedback can also be obtained from the Home Location Register (HLR) 42 and Visitor Location Register (VLR) 43 of the cellular system 4. One form of indirect feedback from the HLR 42 or the VLR 43 can be location of the consumer and its change compared to others as the message is received. FIG. 2 shows a block diagram illustrating the components of the cellular system 4 for conveying indirect feedback to the advertising campaign system 2.

Operation of the campaign response optimizer 23 comprises in high level at least the steps of:
measuring the effect, e.g. response rate, of different type of advertisement delivery methods (SMS, MMS, WAP, Internet AP),
measuring the effect, e.g. response rate, of different type of advertisement contents (text, pictures, videos, html etc.),
calculating cost of delivery and/or a cost per response ratio, and
determining the optimized delivery mechanism.

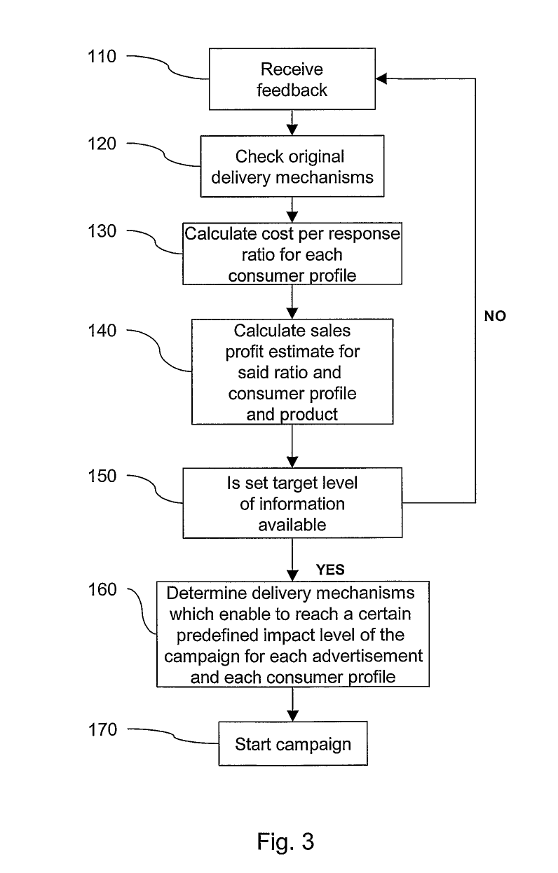

FIG. 3 shows a flow diagram of an example of a method of optimizing delivery mechanisms during a test campaign phase. At 110, feedback from a target group of consumers is received by the advertising campaign system 2. At 120, original delivery mechanisms of the advertisements, to which advertisements feedback from said target group of consumers was received, are checked. At 130, a cost per response ratio for each consumer profile of said target group of consumers is calculated by the campaign response optimizer 23. At 140, sales profit estimates for said ratios, said consumer profiles and products are calculated by the campaign response optimizer 23 using the information fed from the advertisement database 21 and the consumer database 22. At 150, level of information is determined and if the target level is not reached then more feedback is received at 110. At 160, delivery mechanisms which enable to reach a certain predefined impact level of the campaign for each advertisement and each consumer profile are determined by the campaign response optimizer 23. At 170, an actual advertising campaign is started.

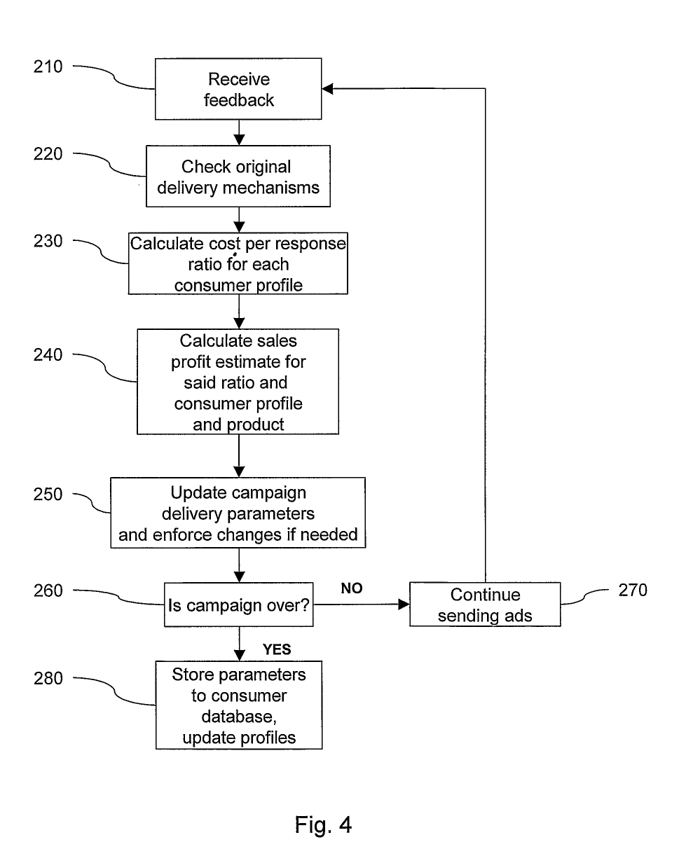

FIG. 4 shows a flow diagram of a method of optimizing delivery mechanisms during an actual advertising campaign. At 210, feedback from consumers is received by the advertising campaign system 2. At 220, original delivery mechanisms of the advertisements, to which advertisements feedback from said consumers was received, are checked. At 230, a cost per response ratio for each consumer profile of said consumers is calculated by the campaign response optimizer 23. At 240, sales profit estimates for said ratios, said consumer profiles and products are calculated by the campaign response optimizer 23 using the information fed from the advertisement database 21 and the consumer database 22. At 250, campaign delivery parameters are updated in the consumer database 22 and changes are enforced if needed. At 260, status of the campaign is determined, and if the campaign is not over then more advertisements are sent at 270 and then feedback is received at 210. At 280, parameters are stored and profiles are updated in the consumer database 22.

The following example illustrates in high level how the campaign response optimizer 23 works. Let us assume that:
1) There are 4 different advertisements for the same product, say soft drink A:
   a) SMS advertisement: “Drink soft drink A”;
   b) MMS advertisement: combination of text “Drink soft drink A” and picture of A;
   c) WAP-push advertisement: combination of text “Drink soft drink A”, picture of A and additional links such as wap.softdrinkA.com; and
   d) advertisement delivered via Internet: 10 sec video clip of the soft drink A and a link to answer a question;
2) Cost C of delivery for SMS is 1 cent (or other money unit), MMS 10 cent, WAP 15 cent and Internet 70 cent.

The four types of advertisements are sent to a representative group of target audience via the cellular system 4 and the feedback, i.e. number of responses, is measured per type of advertisement delivery mechanism. The feedback is fed to the campaign response optimizer 23, for example from the advertiser 1, from the cellular system 4, from a retailer 8, from a mobile terminal 5, or manually via a web interface. Let us further assume that the response rate R of SMS, MMS, WAP and Internet delivered video clip is 1%, 5%, 10% and 20%, respectively. The value of the cost per response ratio I=C/R for each delivery mechanism is:

I_{SMS}=1/1=1, I_{MMS}=10/5=2, I_{WAP}=15/10=1.5 and Iᵢₙₜₑᵣₙₑₜ=70/20=3.5.

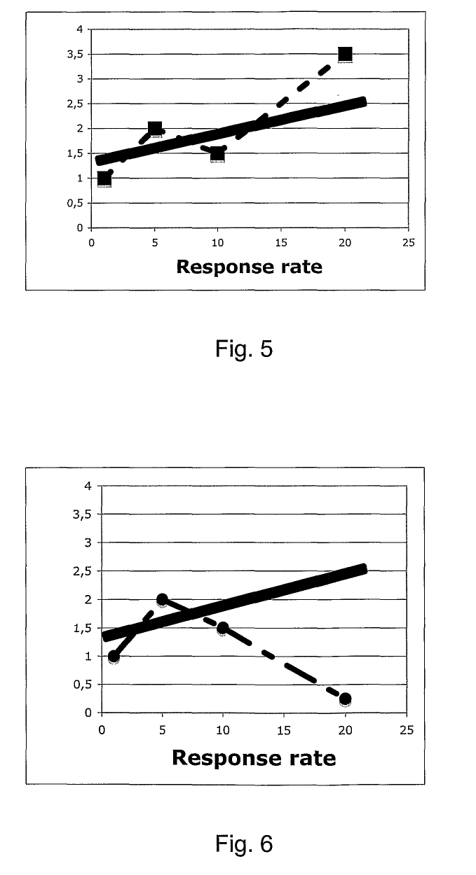

FIG. 5 shows a cost per response ratio as a function of response rate with dashed line. The markers indicate said delivery mechanisms. The advertiser 1 knows the correlation between the response rate and actual sales. That information is fed to the campaign response optimizer 23. FIG. 5 shows this correlation with solid line. In this example SMS and WAP are the only delivery mechanisms, which bring profitable return on the campaign with given assumptions.

In addition or instead calculating only cost per response a parameter such as generated sales per advertisement type can be calculated using the feedback from the consumers 3 and retailers 8.

Additionally, the target consumers have different type of mobile terminals 5 with different capabilities. The advertising campaign system 2 has information about the terminal models. The phone model can be extracted either from the operator infrastructure based on IMEI codes using programs such as NetAct™ from Nokia or the phone models can be stored in the consumer database 22. Now referring to the present example the WAP capable phones will receive a WAP message, phones without WAP capabilities will receive a SMS message.

In addition to terminal capabilities to handle different kind of protocols, terminals have different kind of radio interfaces. For example wireless local area networks are becoming available in many mobile terminals. In some cases the cost of delivery over this type of network can be significantly lower compared to a cellular network for example for video delivery. Referring to the previous example if the price of video delivery would drop down to 5 cent per advertisement using WLAN 6 that would make video advertisements as profitable business. Example of impact of such a scenario for using an alternative access method for the advertisement delivery is shown in FIG. 6. The campaign response optimizer 23 has settable options of preferable delivery mechanisms. In the case of video the criteria for sending a video advertisement is the availability of WLAN access 6 with certain cost for the advertiser. Now taking into consideration the terminal variations the advertising campaign would be run using SMS for SMS only capable phones, WAP for WAP capable and SMS capable phones and video only for the phones with WLAN access and video capabilities.

In order to further expand the advertising campaign optimization to mobile environment and demonstrate benefits over the prior art the optimization is performed not only to single advertisements but also to a chain of advertisements forming advertisement experience for a consumer.

Optimization of a chain advertising campaign comprises in high level the steps of:
testing single advertisements with the campaign response optimizer 23,
running a chain advertising campaign with test groups,
forming a new preferred selection tree structure,
running a full campaign with target groups,
further modifying the chain selection tree if needed. Go back to previous step.

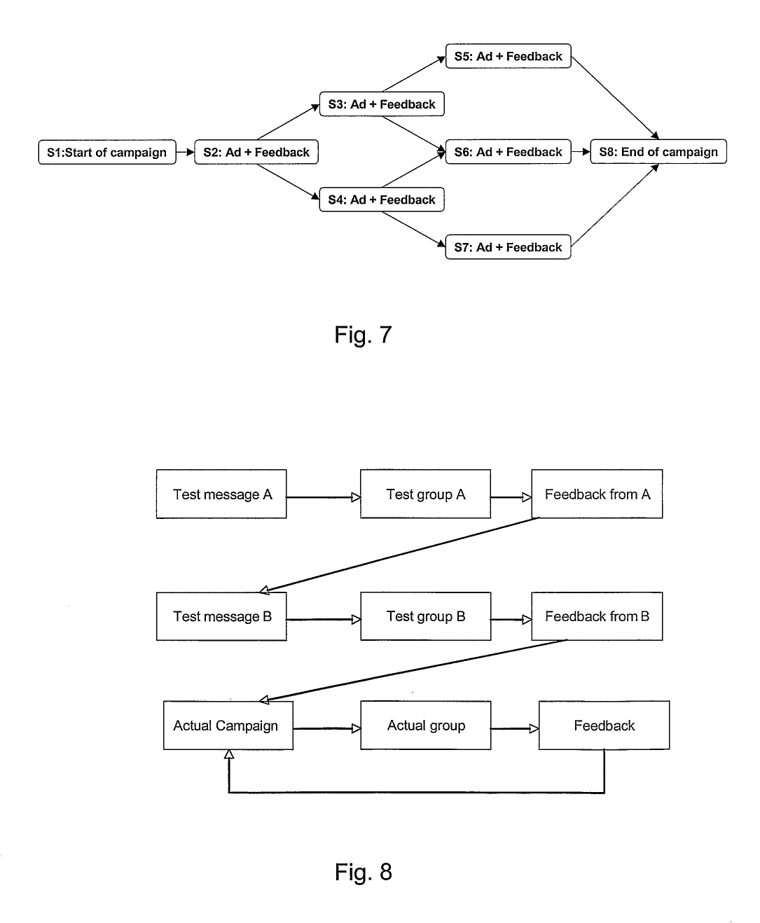

FIG. 7 shows an example tree structure of a chain advertising campaign, which has feedback possibility from the target audience. The structure is as follows: S1 is the start of the campaign. In this phase normally all steps of the campaign have been designed. In this example campaign there is in each step an advertisement with feedback possibility. Based on the feedback the target person receives in the next step an advertisement, which fits best to his/her profile. For example in the S2 the person will be directed either to S3 or S4 depending on the feedback and his/her profile. Alternatively a consumer or a test group member can be given options to select from different alternatives. Selection of the options is considered as feedback.

This campaign is managed in the advertising campaign system 2 (FIG. 1). For each step the delivery mechanism is selected using the campaign response optimizer 23 as described above.

In order to explain the chain advertising campaign optimization in more detail let us assume that person A with profile P_A selects a route S2-S3-S6-S8. The route S2-S3-S6-S8 is stored in the consumer database 22 and associated with person A. In the consumer database 22 the route is stored with related additional information.

This additional information can include the location, time of day, communication activity of the mobile user at the time he/she made the selection. The location is extracted from cellular infrastructure or it can be transmitted from the terminal in form of (GPS) location or cell id where the selection was done or using other info such as WLAN/Bluetooth hotspot identification and location if in proximity of the user device.

Since different people in the peer groups can and do have different type of mobile phones with different technical capabilities the advertisement can look different for different users. For example the capability of viewing high quality video is not available in all phone models. One more parameter, which is associated with a particular decision to select a certain route is the phone model and capability of the phone.

Person A has a personal profile in the consumer database 22 with certain preferences, demographics, hobbies etc. Person A is associated with a peer group PA, a group which resembles person A's behaviour best.

Another person B with a different profile and association to a peer group PB selects an advertisement route S2-S4-S7-S8. This selected route is stored in the consumer database 22 and location information is also added to the consumer database 22.

The chain advertising campaign can be run with a number of test or alpha users of the community. Alpha users are the influencers in the community for the behaviour. The campaign target users can also be selected randomly or from a certain set of profiles.

After running the chain advertising campaign for predetermined time or after sending the campaign to a predetermined number of target consumers or after reaching sufficient confidence level of right selection paths in the campaign the campaign will be run to a next group of audience in a modified form.

The special characteristics of the mobility are taken into account when making this selection tree for the next round. For example if it is evident that most of the persons, independently of the peer group select to go from S2 to S3 in a given location of the network the selection route will be modified to offer S3 as a primary route for everyone in that location. In addition if it is evident from the behaviour that people with mobile terminals with a large colour screen are likely to select always S6 independently where they are or to which peer group they belong the selection tree is modified for them to offer primarily S6 over other alternative advertisements.

One embodiment of how the feedback is used to modify a marketing campaign is shown in FIG. 8. A test message A is sent to a test group A. The feedback from the test group A, or lack of feedback in case of no responses, is analyzed and a new test message B is generated. The test message B is sent to a different test group B. The test group B can include all or some of the consumers of the test group A. The test group B can have one or more new people in the group. Different test groups are preferably used in order to not to disturb the same consumers with too many messages. Feedback to the test message B is analyzed in respect to feedback to the previous test message A and a new test group. If needed, the method is iterated with further test groups (not presented) until desired level of response rate for the advertisements versus targeted expenses related to sending advertisements is reached. Typical total number of consumers in a test group for the messages can be in the range of one thousand, e.g. 500-2000 consumers. The number of consumers can also be significantly lower in the range of few to few tens or few hundreds, e.g. 5-500 or 10-1000, if the test group is selected carefully to represent the target group of the actual campaign. In some cases a test group of one consumer is sufficient. When the target level is reached the marketing message is sent to the actual group of consumers using the selected communication method or methods and the selected message format or formats. The system collects further feedback on the success of the campaign and allows continuous modification of message types and delivery mechanisms.

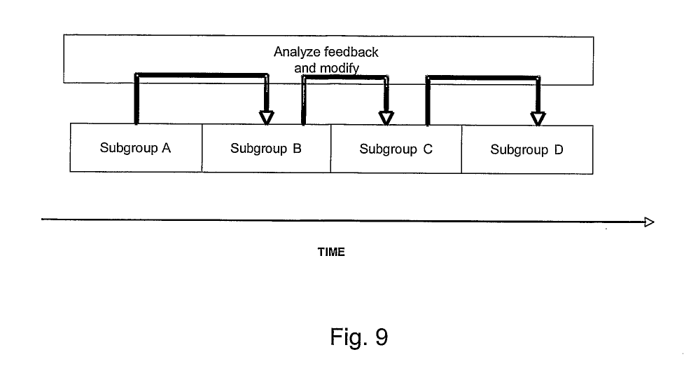

In another embodiment, shown in FIG. 9, the message is not sent to an entire target group of consumers. The target group is divided into N subgroups, i.e. subgroups A-D. The messages are sent to these subgroups in series so that there is time to analyze the success of the campaign for each subgroup before sending advertisements to a next subgroup. The time scale is schematically shown in the FIG. 9. Analysis of the success can also be done to series of feedback from several earlier subgroups in order to decide what to send to the next subgroup. This allows real time feedback and a method for fine-tuning, aborting, redefining or changing the campaign. In this embodiment every previous subgroup and/or cumulative experience on how they behave is used to determine how to approach the next subgroup.

Only advantageous exemplary embodiments of the invention are described in the Figures. It is clear to a person skilled in the art that the invention is not restricted only to the examples presented above, but the invention may vary within the limits of the claims presented hereafter. Some possible embodiments of the invention are described in the dependent claims, and they are not to be considered to restrict the scope of protection of the invention as such.

1. A method for processing messages and feedback, comprising:
selecting a message, from messages stored in a message database, to each consumer in a first group of consumers, which selecting is based on information read from a consumer database,
selecting a delivery mechanism for each said selected message, which selecting is based on information read from the consumer database,
transmitting said selected messages using said selected delivery mechanisms to said first group of consumers through a cellular system,
receiving feedback from said first group of consumers, and
selecting next message and next delivery mechanism based on said received feedback.

2. The method of claim 1, wherein the selected messages are identical.

3. The method of claim 1, wherein the received feedback is direct feedback from said first group of consumers to said selected messages.

4. The method of claim 1, wherein the received feedback is indirect feedback based on consumers' behavior.

5. The method of claim 1, wherein the feedback is received through said cellular system or Internet.

6. The method of claim 1, wherein the selecting the message and the delivery mechanism is based on received feedback from several consumers in the first group of consumers.

7. The method of claim 1, wherein the selecting the message and the delivery mechanism is based on received feedback from one consumer in the first group of consumers.

8. The method of claim 7, wherein the one consumer is an alpha user.

9. The method of claim 1, wherein the information read from said consumer database describes, how consumers utilize features of said cellular system.

10. The method of claim 1, wherein the first group of consumers is a peer group.

11. The method of claim 1, wherein the selected messages advertise one and the same product.

12. The method of claim 1, wherein the selecting a delivery mechanism comprises selecting the way of delivering the message using: SMSC, MMSC, WAP-GW, Internet AP, cellular network, broadcast network, or wireless local area network.

13. The method of claim 1, further comprising storing transmission time of said selected messages and/or receiving time of feedback to said selected messages in said consumer database, such information being used in selecting the message and the delivery mechanism.

14. The method of claim 1, further comprising storing location of consumers, from which feedback has been received, in said consumer database such information being used in selecting the message and the delivery mechanism.

15. The method of claim 1, further comprising storing information content of said received feedback in said consumer database, such information content being used in selecting the message and the delivery mechanism.

16. The method of claim 1, further comprising storing consumers' mobile terminal types in said consumer database, such information being used in selecting the message and the delivery mechanism.

17. The method of claim 1, further comprising:
selecting a message, from messages stored in said message database, to each consumer in a second group of consumers, which selecting is based on information read from said consumer database,
selecting a delivery mechanism for each said selected message, which selecting is based on information read from said consumer database,
transmitting said selected messages using said selected delivery mechanisms to said second group of consumers through said cellular system,
receiving feedback from said second group of consumers, and
selecting the message and the delivery mechanism based on said received feedback.

18. The method of claim 17, wherein the selecting the message and the delivery mechanism is based on received feedback from several consumers in the second group of consumers.

19. The method of claim 17, wherein the selecting the message and the delivery mechanism is based on received feedback from one consumer in the second group of consumers.

20. The method of claim 1, wherein the selecting the message and the delivery mechanism based on said received feedback comprises:
measuring the effect of different type of message delivery mechanisms used,
measuring the effect of different type of message contents used,
calculating cost of delivery and/or a cost per response ratio for the delivery mechanisms and contents, and
determining the optimized delivery mechanism for the messages sent.

21. The method of claim 1, wherein the selecting the message and the delivery mechanism based on said received feedback comprises:
calculating a cost per response ratio for each selected message and delivery mechanism combination and for each consumer profile,
calculating a sales profit estimate for said ratios,
determining if the target level of information is available; if not, then receiving more feedback, and
determining delivery mechanisms, which maximize impact of the campaign for each message and each consumer profile.

22. The method of claim 1, wherein the feedback is retrieved as indirect feedback from a billing system of the cellular system.

23. The method of claim 1, wherein the feedback is retrieved as indirect feedback from call detail records of the cellular system.

24. The method of claim 17, wherein the selection of the messages to a group of users is done based to feedback of the previously sent messages to a previous group of users.

25. The method of claim 1, wherein said selecting a delivery mechanism comprises the selection of
a communication network to be used for the delivery of the message,
a delivery method to be used for the message to be sent,
a message type of the message to be sent.

26. A system for processing messages and feedback, comprising:
a message database configured to store messages,
a consumer database of a cellular system configured to store information that describes properties of consumers,
a consumer selecting arrangement configured to select at least a first group of consumers based on information read from said consumer database,
a message selecting arrangement configured to select messages from said message database to the first group of consumers based on information read from said consumer database,
a delivery mechanism selecting arrangement configured to select a delivery mechanism to each selected message based on information read from said consumer database,
a transmission arrangement configured to transmit selected messages to the first group of consumers through said cellular system, and
a receiving arrangement configured to receive feedback from consumers to which messages have been sent through said cellular system,
wherein the message selecting arrangement is configured to select the messages based also on said received feedback, and wherein the delivery mechanism selecting arrangement is configured to select the delivery mechanism based also on said received feedback.

27. The system of claim 26, wherein the message selecting arrangement is configured to select identical messages for each consumer in the first group of consumers.

28. The system of claim 26, wherein the receiving arrangement is configured to receive direct feedback from said first group of consumers to said selected messages.

29. The system of claim 26, wherein the receiving arrangement is configured to receive indirect feedback based on consumers' behavior.

30. The system of claim 26, wherein the receiving arrangement is configured to receive feedback through said cellular system or Internet.

31. The system of claim 26, wherein the message selecting arrangement is configured to select the message and the delivery mechanism selecting arrangement is configured to select the delivery mechanism based on received feedback from several consumers in the first group of consumers.

32. The system of claim 26, wherein the message selecting arrangement is configured to select the message and the delivery mechanism selecting arrangement is configured to select the delivery mechanism based on received feedback from one consumer in the first group of consumers.

33. The system of claim 26, wherein the consumer database is configured to store information that describes how consumers utilize features of said cellular system.

34. The system of claim 26, wherein said consumer selecting arrangement is configured to select the first group of consumers as a peer group.

35. The system of claim 26, wherein said message selecting arrangement is configured to select messages that advertise one and the same product.

36. The system of claim 26, wherein said delivery mechanism selecting arrangement is configured to select the way of delivering the message from the group of: SMSC, MMSC, WAP-GW, Internet AP, cellular network, broadcast network, or wireless local area network.

37. The system of claim 26, wherein the system is configured to store transmission time of said selected messages and/or receiving time of feedback to said selected messages in said consumer database, and the message selecting arrangement is configured to select the message and the delivery mechanism selecting arrangement is configured to select the delivery mechanism based on such information.

38. The system of claim 26, wherein the system is configured to store location of consumers, from which feedback has been received, in said consumer database, and the message selecting arrangement is configured to select the message and the delivery mechanism selecting arrangement is configured to select the delivery mechanism based on such information.

39. The system of claim 26, wherein the system is configured to store information content of said received feedback in said consumer database, and the message selecting arrangement is configured to select the message and the delivery mechanism selecting arrangement is configured to select the delivery mechanism based on such information.

40. The system of claim 26, wherein the system is configured to store consumers' mobile terminal types in said consumer database, and the message selecting arrangement is configured to select the message and the delivery mechanism selecting arrangement is configured to select the delivery mechanism based on such information.

41. The system of claim 26, wherein
consumer selecting arrangement is configured to select a second group of consumers based on information read from said consumer database,
message selecting arrangement is configured to select messages from said message database to the second group of consumers based on information read from said consumer database,
the transmission arrangement is configured to transmit selected messages to the second group of consumers through said cellular system,
the message selecting arrangement is configured to select the messages based also on received feedback from the second group of consumers, and
the delivery mechanism selecting arrangement is configured to select the delivery mechanism based also on received feedback from the second group of consumers.

42. The system of claim 41, wherein the message selecting arrangement is configured to select the message and the delivery mechanism selecting arrangement is configured to select the delivery mechanism based on received feedback from several consumers in the second group of consumers.

43. The system of claim 41, wherein the message selecting arrangement is configured to select the message and the delivery mechanism selecting arrangement is configured to select the delivery mechanism based on received feedback from one consumer in the second group of consumers.

44. The system of claim 26, wherein the system is configured to:
measure the effect of different type of message delivery mechanisms used,
measure the effect of different type of message contents used,
calculate cost of delivery and/or a cost per response ratio for the delivery mechanisms and contents, and
determine the optimized delivery mechanism for the messages sent.

45. The system of claim 26, wherein the system is configured to:
calculate a cost per response ratio for each selected message and delivery mechanism combination and for each consumer profile,
calculate a sales profit estimate for said ratios,
determine if a predetermined target level of information is available; if not, then the system is configured to receive more feedback, and
determine delivery mechanisms, which maximize impact of the campaign for each message and each consumer profile.

46. The system of claim 26, wherein the receiving arrangement is configured to receive feedback as indirect feedback from a billing system of the cellular system.

47. The system of claim 26, wherein the receiving arrangement is configured to receive feedback as indirect feedback from call detail records of the cellular system.

48. The system of claim 41, wherein the message selecting arrangement is configured to select the messages to a group of users based on feedback of the previously sent messages to a previous group of users.

49. The system of claim 26, wherein the delivery mechanism selecting arrangement is configured to select
a communication network to be used for the delivery of the message,
a delivery method to be used for the message to be sent, and
a message type of the message to be sent.
